(19) United States
(12) Patent Application Publication
(10) Pub. No.: US 2024/0394549 A1
(43) Pub. Date: Nov. 28, 2024

(54) USING LANGUAGE MODELS TO IMPROVE THE EXPLAINABILITY OF MACHINE LEARNING SYSTEMS

(71) Applicant: Zeta Global Corp., New York, NY (US)

(72) Inventors: Zachary Jones, Decatur, GA (US); Danny Portman, Johns Creek, GA (US)

(21) Appl. No.: 18/676,340

(22) Filed: May 28, 2024

Related U.S. Application Data
(60) Provisional application No. 63/469,392, filed on May 27, 2023.

(51) Int. Cl. G06N 3/0895

(52) U.S. Cl. CPC G06N 3/0895

(57) ABSTRACT

The subject technology uses a bootstrapping approach to train language models (LMs) to explain outcomes determined by neural networks, ensemble models, reinforcement learning models, LMs, and other black box machine learning models. The bootstrapping approach may train multiple iterations of a tuned LM using training data determined from progressively complex machine learning models and progressively detailed natural language explanations. The model explanations determined by the tuned LM may be displayed in a user interface (UI) included in a publishing system to provide users more context about and a greater understanding of the decision making process used by the black box machine learning models to determine outcomes.

### PRIORITY CLAIM

This patent application claims the benefit of priority, under 35 U.S.C. Section 119 (e), to Jones et al, U.S. Provisional Patent Application Ser. No. 63/469,392, entitled “ARTIFICIAL INTELLIGENCE SYSTEM FOR MODEL EXPLAINABILITY,” filed on May 27, 2023 (Attorney Docket No. 4525.188PRV), which is hereby incorporated by reference in its entirety.

### TECHNICAL FIELD

The subject matter disclosed herein generally relates to the technical field of machine learning used in a network-based computing environment. In particular, the disclosure recites improved machine learning technology that uses language models (LMs) to generate explanations for outcomes generated by machine learning systems.

### BACKGROUND

The present subject matter seeks to address technical problems existing in generating explanations for outcomes (e.g., predictions, insights, and the like) determined by machine learning systems (e.g., neural networks, ensemble models, reinforcement learning models, language models, and the like). Machine learning systems currently operate like a black box. These tools have thousands, millions, or even billions, of trainable parameters that influence their outcomes but lack mechanisms for explaining why a particular outcome was determined. The lack of transparency into the decision making process of machine systems makes it difficult to detect system biases and determine the model features that are important for determining an outcome. The technology described herein improves the accuracy of machine learning systems by reducing the amount of model bias. This technology also improves the efficiency and speed of model training by removing features that are unnecessary for accurate outcomes from training datasets and reducing the number of model parameters. The technology also makes machine learning models more interpretable so that the limitations of each model may be identified. The insights into the limitations provided by the technology described herein may be used to improve the performance of machine learning models by incorporating tuning steps to address the identified limitations into the model training process.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of a learning module, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts aspects of an explainability engine, according to various embodiments described herein.

FIG. 7 illustrates more details of a training prompt, according to various embodiments described herein.

FIG. 8 illustrates an example language model (LM), according to various embodiments described herein.

FIG. 9 illustrates more details of operations of the explainability engine at runtime, according to various embodiments described herein.

FIG. 10 is a flow chart illustrating operations in a training method, according to various embodiments described herein.

FIG. 11 is a flow chart depicting operations in a method, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The embodiments discussed herein involve or relate to artificial intelligence (AI). AI may involve perceiving, synthesizing, inferring, predicting and/or generating information using computerized tools and techniques (e.g., machine learning). For example, AI systems may use a combination of hardware and software as a foundation for rapidly performing complex operations to perceive, synthesize, infer, predict, and/or generate information. AI systems may use one or more models, which may have a particular configuration (e.g., model parameters and relationships between those parameters, as discussed below). While a model may have an initial configuration, this configuration can change over time as the model learns from input data (e.g., training data), which allows the model improve its abilities. For example, a dataset may be input to a model, which may produce an output based on the dataset and the configuration of the model itself. Then, based on additional information (e.g., an additional input dataset, validation data, reference data, feedback data), the model may deduce and automatically electronically implement a change to its configuration that will lead to an improved output.

Powerful combinations of model parameters and sufficiently large datasets, together with high-processing-capability hardware, can produce sophisticated models. These models enable AI systems to interpret incredible amounts of information, which would otherwise be impractical, if not impossible, for the human mind to accomplish. The results, including the results of the embodiments discussed herein, are astounding across a variety of applications. For example, an AI system can be configured to autonomously operate computers, vehicles and other machines, automatically recognize objects, instantly generate natural language, recognize patterns in large datasets, understand human speech, and generate artistic images.

Language models including large language models (LMs) of various capabilities, described herein, may be used to improve the versatility and robustness of Application Programming Interfaces (APIs) and applications to perform a multitude of tasks. Training on specific instructions, tools, and thought chains, may extend the functionality of LMs beyond understanding and generating natural language or code to encompass understanding the operations of other machine learning systems. The training techniques described below may optimize language models (LMs) to explain the reasoning behind outcomes determined by neural networks, ensemble models, reinforcement learning models, LMs, and other target machine learning models. The explanations provided by the LMs may be used to increase the accuracy of target models by revealing model basis that may be eliminated by training subsequent model iterations. The explanations may also be used to identify important features and unnecessary features for making a particular outcome. The unnecessary features may be eliminated from the training data in order to reduce model dimensionality and increase the efficiency of model training operations.

The explanations generated by the technology described herein may be displayed in a user interface (UI) (e.g., a content campaign configuration UI, campaign monitoring UI, insights UI, analytics UI, and the like) of a publishing system. The explanations may be displayed in the UI alongside and/or adjacent to a prediction, insight, or other machine learned outcome and may improve the user experience of the publishing system by providing users more details about the reasoning process one or more machine learning models used to determine the predictions and/or insights. In various embodiments, the explanations may be displayed inside a popup menu or a hover menu that appears when inputs into the UI indicate a user is hovering, clicking, or interacting with an insight from a machine learning model that is displayed in the UI. The explanations may provide context explaining the primary factors considered by machine learning models when determining outcomes to build model credibility and increase user trust in the model. The explanations may also include actionable insights that may be extracted and used during creative design, audience segmentation, channel selection, budget allocation, and other content campaign configuration operations.

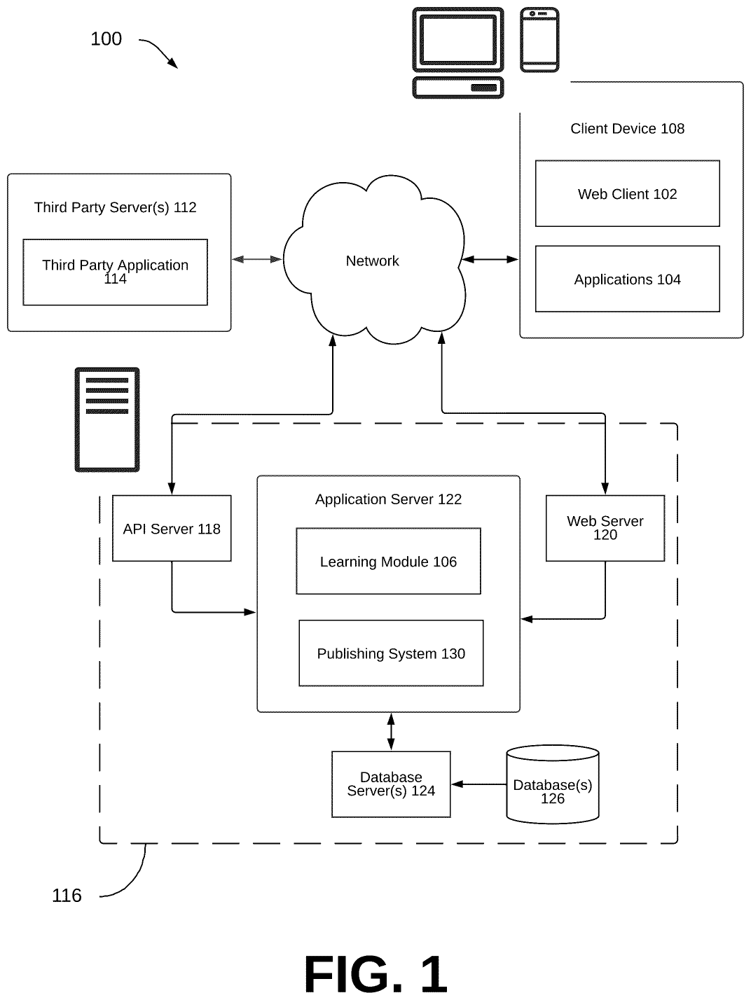

The explainability engine may be implemented within the SaaS network architecture described in FIG. 1 below so that the model explanation functionality may be scaled to generate accurate, insightful explanations for multiple target models. LMs may be tuned on training datasets that are unique for each target model so that the explanations are optimized for each model and outcome type.

With reference to FIG. 1, an example embodiment of a high-level SaaS network architecture 100 is shown. A networked system 116 provides server-side functionality via a network 110 (e.g., the Internet or WAN) to a client device 108. A web client 102 and a programmatic client, in the example form of a client application 104, are hosted and execute on the client device 108. The networked system 116 includes an application server 122, which in turn hosts a publishing system 130 (such as a demand side platform (DSP), message transfer agent (MTA), and the like) that provides a number of functions and services to the client application 104 that accesses the networked system 116. The client application 104 also provides a number of user interfaces (UIs) (e.g. graphical user interfaces (GUIs)) described herein that may be displayed on one or more client devices 108 and may receive inputs thereto to configure an instance of the client application 104 and monitor operations performed by the application server 122. For example, the client application 104 may provide configuration UIs for selecting content creatives, audience segments, budget allocations, publishing channels, and other configuration settings for one or more content campaigns. The client application 104 may also provide UIs for creating LM prompts and tracking model and campaign performance. The UIs can present outputs to a user of the client device 108 and receive inputs thereto in accordance with the methods described herein.

The client device 108 enables a user to access and interact with the networked system 116 and, ultimately, the learning module 106. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the learning module 106, which includes components or applications described further below. The application server 122 may also host a publishing system 130 that distributes content on one or more channels including email, web display, mobile display, social media, linear tv, streaming, and the like. The application server 122 is, in turn, shown to be coupled to a database server 124 that facilitates access to information storage repositories (e.g., a database 126). In an example embodiment, the database 126 includes storage devices that store information accessed and generated by the learning module 106.

The publishing system 130 may be a demand side platform (DSP), email service provider (ESP) or other system that distributes content digitally over a network. For example, the publishing system may be a DSP that includes an integrated bidding exchange, an online demand side portal accessible to a targeted content provider, and an online supply side portal accessible to a publisher of content on the publication network 110. The bidding exchange may be communicatively coupled to the demand side portal and the supply side portal to present user interfaces enabling receipt of bids from a brand or other media provider for placement of content and other media by a publisher at a specified location or domain in available inventory on the publication network 110. In some examples, the publishing system 130 may be configured to present media to a consumer at a specified location or domain on the publication network based on one or more outcomes generated may a machine learning model or generative AI system included in the learning module 106. For example, a bidding model included in the learning module 106 may determine an amount for an optimal bid for a placement. The demand side portal may, upon receiving a signal from the media provider that the optimal bid is successful (i.e., the highest bid for the placement), reserve the placement at the specified location or domain. The demand side portal may then publish the piece of media at the reserved placement. Users accessing the locations including the reserved placements may view and engage with the media. In some examples, the publishing system 130 is further configured to process a transaction between the media provider and the publisher based on the presentation or a viewing of the targeted media by the consumer, or a third party. Accordingly, the publishing system 130 and learning module 106 may work in concert to enable scalable digital media campaigns that publish target content to an audience segment on one or more channels.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions on a generative AI system, website, streaming platform hosted by a third party.

Turning now specifically to the applications hosted by the client device 108, the web client 102 may access the various systems (e.g., the learning module 106) via the web interface supported by the web server 120. Similarly, the client application 104 (e.g., a digital marketing “app”) accesses the various services and functions provided by the learning module 106 via the programmatic interface provided by the API server 118. The client application 104 may be, for example, an “app” executing on the client device 108, such as an iOS or Android OS application, to enable a user to access and input data on the networked system 116 in an offline manner and to perform batch-mode communications between the client application 104 and the networked system 116. The client application 104 may also be a web application or other software application executing on the client device 108.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The learning module 106 could also be implemented as a standalone software program, which does not necessarily have networking capabilities.

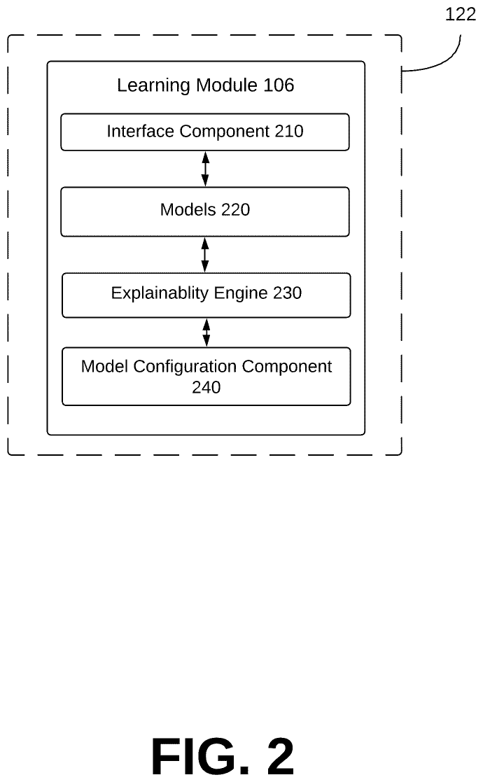

FIG. 2 is a block diagram showing architectural details of a learning module 106, according to some example embodiments. Specifically, learning module 106 is shown to include an interface component 210 by which the learning module 106 communicates (e.g., over a network 110) with other systems within the SaaS network architecture 100.

The interface component 210 is collectively coupled to one or more models 220 that operate to provide outcomes used to configure new content campaigns and provide insights about datasets and campaigns available and/or running on the publishing system 130. The models 220 may include seed models that are inherently explainable. Seed models may include linear regression models, decision trees, and other machine learning models with a limited number of trainable parameters (e.g., 1 to 100 parameters) and/or identifiable logical paths that are interpretable by humans. The models 220 may also include target models that are more complex than seed models and are not inherently explainable. Target models may include neural networks, ensemble models, reinforcement learning models, LMs, and other machine learning and/or artificial intelligence models that have hundreds, thousands, millions, or even billions of trainable parameters and one or more hidden layers that influence model output in ways that are not fully understood and not explainable with natural language. An explainability engine 230 coupled to the models 220 implements a bootstrapping approach to provide natural language explanations for outcomes determined by seed and target models. The operations of the explainability engine 230 are covered in detail below with reference to the accompanying drawings. A model configuration component 240 connected to the explainability engine 230 may use the model explanations to improve the performance of one or more of the models 220. Model explanations from the explainability engine 230 may also be provided to the interface component 210 for display in one or more UIs of the publishing system 130.

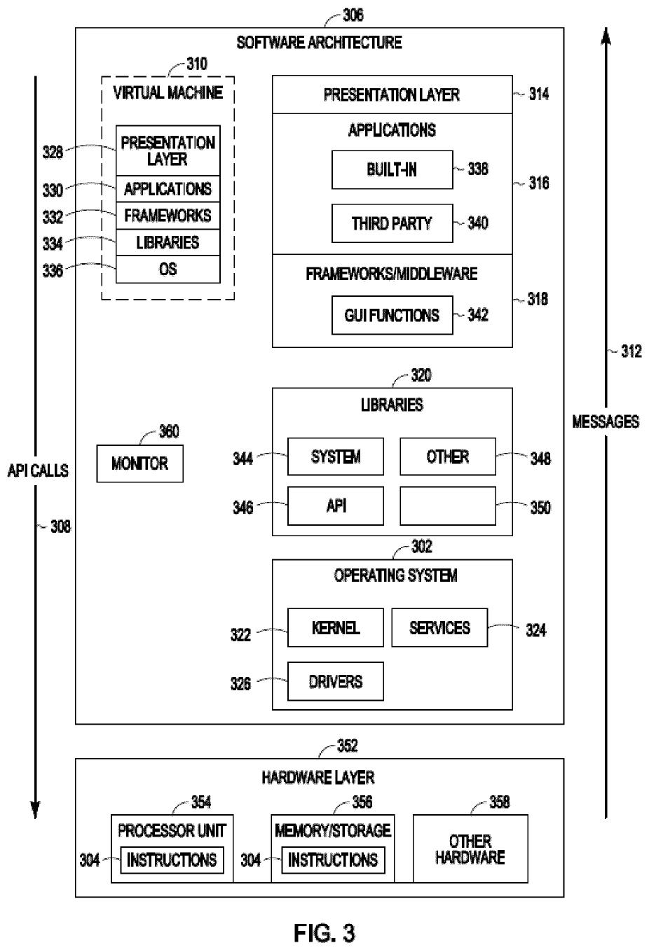

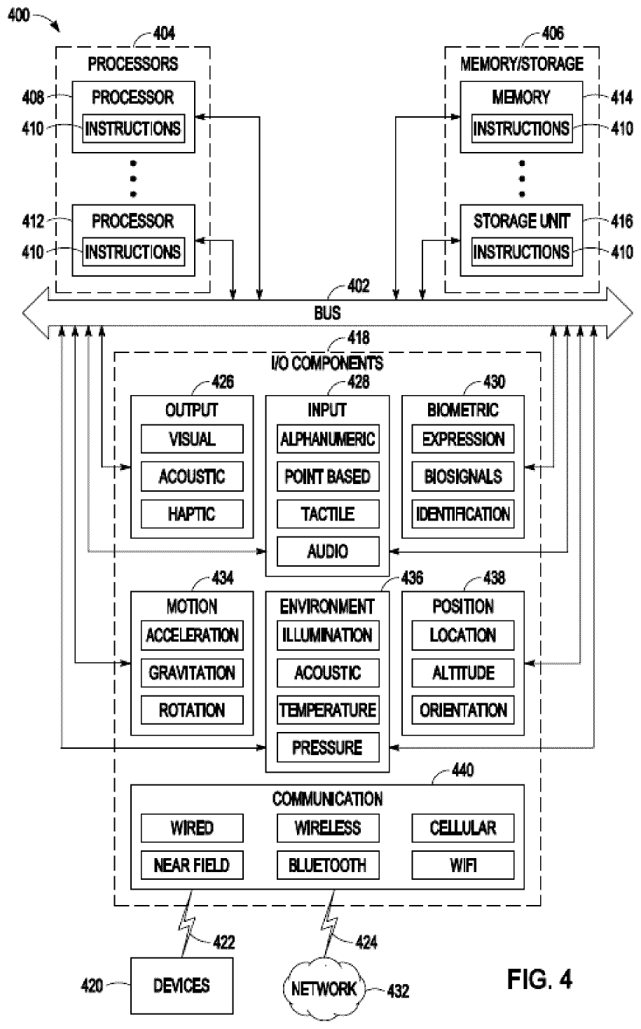

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

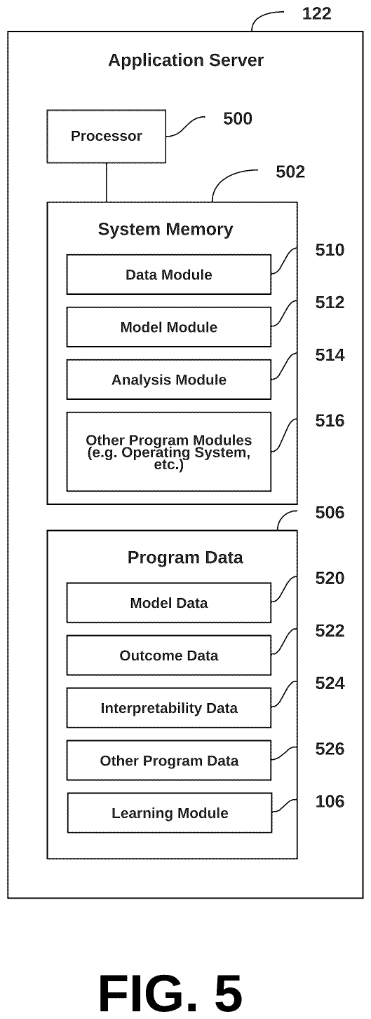

With reference to FIG. 5, an application server 122 hosting a learning module may include at least one processor 502 coupled to a system memory 504. The system memory 504 may include computer program modules 506 and program data 508. In this implementation, program modules 506 may include a data module 510, a model module 512, an analysis module 514, and other program modules 516 such as an operating system, device drivers, and so forth. Each module 510 through 516 may include a respective set of computer-program instructions executable by one or more processors 502.

This is one example of a set of program modules, and other numbers and arrangements of program modules are contemplated as a function of the particular design and/or architecture of the explainability engine. Additionally, although shown as a single application server, the operations associated with respective computer-program instructions in the program modules 506 could be distributed across multiple computing devices. Program data 508 may include model data 520, outcome data 522, and interpretability data 524, and other program data 526 such as data input(s), third-party data, and/or others. In some examples, instructions providing the operations and functionality of the learning module 106 may also be stored in program data 508.

In various embodiments, model data 520 may include each of the trained models (e.g., the structure and trained parameters for each model) included in the learning module 106, the training data for each model, outcomes for a validation sample of model inputs, and/or labeled outcomes for each unique model input. Outcome data 522 may include predictions, insights, and other outcomes generated by the model and values for each model feature and/or trained parameter that were used to determine the outcomes. Interpretability data 524 may include one or more interpretability metrics or explanations determined for each model. In various embodiments one or more pieces of model data 520 and/or outcome data 522 may be used to determine one or more interpretability metrics. For example, values for one or more model features may be used to determine explanations for seed models and model data may be used to determine SHapley Additive explanations (SHAP) values and other interpretability metrics.

One or more pieces of model data 520, outcome data 522, and/or interpretability data 524 may be included in training samples used to tune one or more large language models. The explainability engine may assemble the tuning dataset training datasets, generate prompts including the training data, and tune LMs using the prompts. The tuned LMs may then be used to generate tuning dataset training datasets for more complex versions of the models.

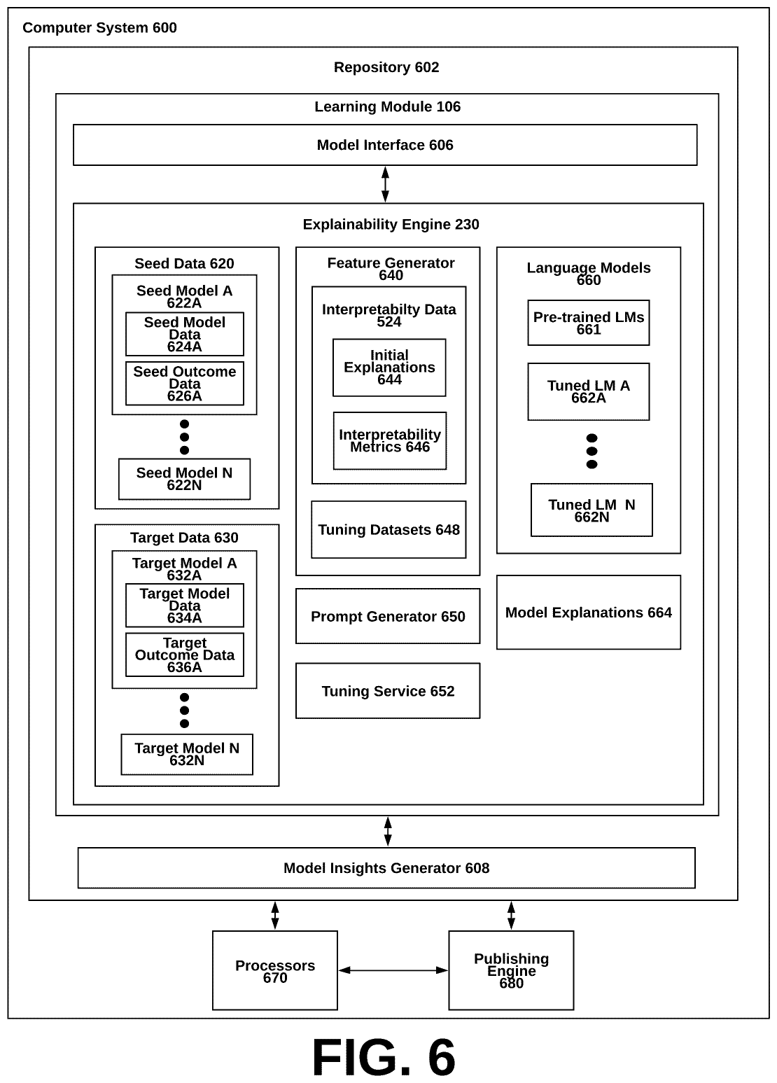

FIG. 6 is a block diagram illustrating more details of the learning module 106 in accordance with one or more embodiments of the disclosure. The learning module 106 may be implemented using a computer system 600. In various embodiments, the computer system 600 may include a repository 602, a publishing engine 680, and one or more computer processors 670. In one or more embodiments, the computer system 600 takes the form of the application server 122 described above in FIG. 1 or takes the form of any other computer including a processor and memory. In one or more embodiments, the computer processor(s) 670 takes the form of the processor 500 described in FIG. 5.

In one or more embodiments, the repository 602 may be any type of storage unit and/or device (e.g., a file system, database, collection of tables, or any other storage mechanism) for storing data. Further, the repository 602 may include multiple different storage units and/or devices. The multiple different storage units and/or devices may or may not be of the same type or located at the same physical site. The repository 602 may include a data preprocessing module 604, the learning module 106, and a model insights generator 608.

At runtime, a publishing engine 680 of the publishing system may provide one or more UIs (e.g., campaign configuration UIs, audience segmentation UIs, opportunity explorer UIs, and the like) to one or more client devices. The UIs may include predictions and/or insights determined by one or more machine learning models included in the learning module 106. For example, predictions may include one or more machine generated scores (e.g., brand affinity scores, product propensity scores, topic affinity scores, personality propensity scores, and the like) and/or predicted metrics (e.g., predicted click though rate, predicted open rate, predicted views, predicted sales, and the like) that are used to build creative assets, segment audiences, select channels, allocate budgets, and perform other content campaign configuration operations. Insights may include one or more trends in datasets (e.g., customer data, campaign performance data, content spend data, and the like) observed by one or more machine learning models. Additionally, the insights may be a call to action, suggestion, classification, or other determination made by one or more of the machine learning models based on an underlying data analysis. An explainability engine 230 included in the learning module 106 may generate model explanations 664 for one or more of these predictions and/or insights. The model insights generator 608 may transmit the model explanations 664 for each prediction and/or insight to the publishing engine 680.

The model explanations 664 may be displayed along with their corresponding predictions and/or insights in one or more UIs. In various embodiments, the model explanations 664 may be displayed in a static UI component alongside their corresponding predictions and/or insights so that the model explanations 664 are always viewable by users of the publishing system. The publishing engine 680 may also display the model explanations 664 in a dynamic UI component (e.g., a popup menu, hover menu, and the like) that appears in response to user engagement with a UI object or other UI component displaying a prediction and/or insight. For example, the dynamic UI component including the model explanation 664 may appear adjacent to or over a UI object displaying an outcome in response in response to inputs into the UI (e.g., inputs received from a client device) indicating a user is interacting with (e.g., clicking on, hovering over, and the like) the UI object displaying the prediction and/or insight. The explainability engine 230 may dynamically generate model explanations 664 for predictions and/or insights displayed in UIs generated by the publishing system in real time so that each displayed prediction and/or insight may have a corresponding model explanation 664. The technology used to determine the model explanations 664 is described in detail below.

The explainability engine 230 may interact with the machine learning models included in the learning module 106 though a model interface 606. To implement the bootstrapping approach described herein, multiple iterations of the models used to generate each outcome are trained and stored in the learning module 106. The multiple model iterations may include one or more seed models and one or more target models for each unique outcome type.

Seed models are inherently explainable and the model features that contributed to the determined outcome (e.g., influenced the model's decision to make a particular prediction or draw a particular insight) are readily identifiable. Seed models may include linear regression models, decision trees, and other machine learning models with a limited number of trainable parameters (e.g., 1 to 20 parameters) and/or identifiable logical paths that are interpretable by humans. Target models are more complex than seed models and are not inherently explainable. Target models operate as opaque black boxes that determine outcomes (e.g., generate predictions and draw insights) using lines of reasoning or interpretations of model features that are not readily identifiable or understandable by humans. The computational complexity of the target models is too complex to be cognizable by humans without specialized explainability tools (e.g., the explainability engine 230). Target models may include neural networks, ensemble models, reinforcement learning models, LMs (e.g., large language models and other generative AI), and other machine learning and/or artificial intelligence models that have hundreds, thousands, millions, or even billions of trainable parameters and multiple (e.g, tens, hundreds, thousands, or even millions) of hidden layers that influence model output in ways that are not fully understood and not explainable with natural language.

The learning module 106 may build multiple iterations of each seed and/or target model (e.g, each seed and/or target model trained to make particular prediction, draw a particular insight, and/or perform a particular task). The explainability engine 230 may use the multiple model iterations to implement a bootstrapping approach that scales the complexity of the model explanations 664 to match the complexity of the machine learning models. The explainability engine 230 may implement the bootstrapping approach by tuning language models 660 (e.g., a pre-trained LMs 661) for target models of a particular complexity level using tuning datasets 648 including features, outputs, completions, and other training data from increasingly complex models. For example, the explainability engine 230 may tune a pre-trained LM 661 to generate a first tuned LM 662A that determines a model explanation 664 for the simplest target model (e.g., a version target model having the least amount of features or fewest number of layers) trained for a type of task (e.g., determine product propensity scores, determine brand affinity scores, predict a particular metric, and the like). The first tuned LM 662A may be trained using a tuning dataset 648 that includes training data from a seed model and the simplest target model. The model explanation 664 from the first tuned LM 662A may be used to train a second tuned LM 662B. For example, second tuned LM 662B may be trained by re-training the LM on a tuning dataset 648 that includes the model explanation from the first tuned LM 662A and outputs from a more complex target model (e.g., a version of the target model having more features and/or more layers than the simplest target model). Additional tuned LMs 662N may be trained using this bootstrapping methodology until a tuned LM is trained on outputs from the most complex target model available for a particular task, prediction, and/or insight.

To train the tuned LMs 662A, . . . , 662N, the explainability engine 230 may assemble tuning datasets 648 using outputs from multiple models. Seed data 620 for the seed models 622A, . . . , 622N and target data 630 for the target models 632A, . . . , 632N may be received from the model interface 606. Seed data 620 may include seed model data 624A and seed outcome data 626A for each of the seed models built for a particular prediction, insight, and/or task. Target data 630 may include target model data 634A and target outcome data 636A for each of the target models built for a particular prediction, insight, and/or task. The seed and target model data 624A, 634A may include the trained seed and target models respectively (e.g., the structure of the models, the values for the trained parameters for each model, and the like), the training data used to train each model, the outcomes for a validation sample of model inputs (e.g., feature vectors) generated by the models, and/or labeled outcomes for each unique model input. The seed and target outcome data 626A, 636N may include outcomes generated by the each model for a sample of inputs and the values for each model feature and/or trained parameter that were used to determine the outcomes.

A feature generator 640 may determine interpretability data 524 for each seed model 622A, . . . , 622N and each target model 632A, . . . , 632N. Interpretability data 524 may include one or more interpretability metrics 646 and/or initial explanations 644 for the outcomes determined by each seed and target model. The feature generator 640 may generate initial explanations 644 for each seed model 622A, . . . , 622N using an explanation function that iterates through the model's architecture and the feature values generated by the model for each input feature vector to determine the features of the feature vector that were most important to the outcome (e.g., the prediction and/or insights) determined by the model. For example, to determine an initial explanation 644 for a decision tree type seed model, the explanation function may follow the logical paths of the model's tree structure and determine the values for each feature along the path that direct the model to the determined outcome. One or more names and values for features that caused the model to divert in the direction of the predicted outcome may be included in the initial explanation 644 determined by the explanation function. To determine an initial explanation 664 for a linear regression seed model, the explanation function may determine the weights for each parameter included in the model's objective function and compare the weights to an importance threshold. Parameters having weights that meet or exceed the importance threshold may be determined to be the most influential features in the model's decision to predict the outcome and may be included in the initial explanation 644. The explanation function may generate an initial explanation 644 that recites the outcome determined by the model and the most influential features identified by the function. For example, an initial explanation 644 for credit card affinity score of 0.83 for a sample (e.g., a sample of customer data) determined by a credit card affinity model may be, “the sample was predicted to have a credit card affinity of 0.83 because the credit score feature was higher than 600 and the credit utilization feature was less than 20%”.

The feature generator 640 may also generate one or more interpretability metrics 646 for target models. For example, the feature generator 640 may determine the SHAP values for each feature of a target model. The SHAP values may be determined by a SHAP function that evaluates feature importance based on a comprehensive understanding of the model's behavior that accounts for interactions between features. To determine SHAP values, the SHAP function may modify a target model by selectively removing one or more model features and using the modified model to determine an outcome. For example, the SHAP function may iteratively generate different modified versions of a target model with each model version having different sets of model features. The SHAP function may create different set of model features by selectively removing and/or including one or more original features from the model feature set for each version of the model. For target models with hundreds of features the SHAP function may create thousands of different versions of the model with each version including different combinations of features. The SHAP function then calculates the difference between the outcome determined by versions of the model with and without each feature. This calculation may be determined for each model version to determine the contribution of each feature in the model to the determine outcome. The contributions of each feature to the outcomes generated by each model version may be measured in terms of changes to an expected value of the model's output or other baseline (e.g., global mean for the outcome values across all samples, a specific outcome value for a particular sample, and the like). The feature contributions from each model version are combined and weighted using the Shapley value concept from game theory to generate the SHAP values. The SHAP function determines the SHAP values by assigning weights to each feature based on their calculated contribution and the order in which they were included in the model versions. SHAP values that contribute to the model outcome are positive values and SHAP values that detract from the model outcome (i.e., suggest an alternative outcome, insight, or other outcome) are negative values. The magnitude of the SHAP value reflects the degree to which feature contributed or detracted from the determined outcome.

SHAP values may be normalized by scaling the values to a predetermined range (e.g., from 1 to −1). Features with SHAP values close to 1 (e.g., 0.8, 0.9, and the like) have a large contribution to the outcome and are very influential in the model's decision making process. Features with SHAP values close to −1 (e.g., −0.9, −0.8) detracted from the outcome and were indicators in favor of a different outcome, therefore features with SHAP values close to −1 had a minimal or no impact on the outcome. Features with SHAP values close to 0 (e.g., 0.01, 0.02, and the like) also had a small or insignificant contribution to the outcome and were not heavily relied on by the model during its decision making process. Accordingly, the features with the high, positive SHAP values may be determined to have the greatest effect the outcome and be considered the most important features in the model's decision making process. Features with low positive SHAP values or negative SHAP values may be determined to have the weakest or no effect on the outcome and may be considered unimportant features in the model's decision making process.

The feature generator 640 assembles tuning datasets 648 using the model data 624, . . . , 624N, outcome data 626A, . . . , 626N, and interpretability data 524 for a pair of models. For example, the tuning datasets 648 may include multiple tuples with each tuple including a determined outcome, SHAP values, and an explanation. To generate the tuples, a seed model may be used to determine outcomes for a test sample (e.g., multiple data samples represented as feature vectors and having known outcomes). Instances where the outcome determined by the seed model does not match the known outcomes (e.g., incorrect outcomes) are discarded. An initial explanation 644 for each correct outcome from the seed model is determined by an explanation function of the feature generator 640. A target model determines outcomes for the selection of data samples in the test sample that received correct outcomes from the seed model. The outcomes, for each sample in the selection, determined by the seed model and target model may be compared. For samples having matching outcomes from the seed and target models, the feature generator 640 computes SHAP values for each feature value calculated by the target model. Samples with mismatched outcomes from the seed and target models may be discarded. The feature generator 640 may aggregate the correct outcome, the explanation for the seed model, and the SHAP values for the target model in a tuple. The tuples determined for each of the remaining data samples may be aggregated in a tuning dataset 648.

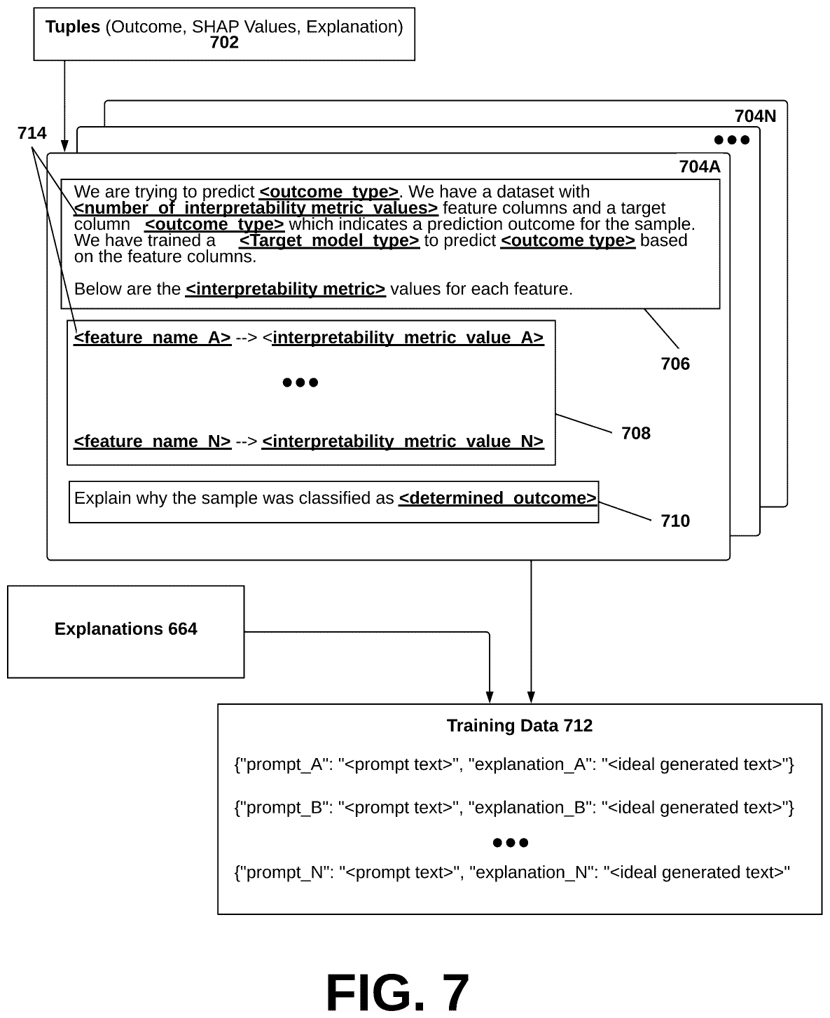

For each tuple in the tuning dataset 648, the prompt generator 650 may generate a tuning prompt that is provided to the tuning service 652. The tuning service 652 may train an LM using the tuning prompts. FIG. 7 illustrates an example of the tuning prompts 704A, . . . , 704N determined by the prompt generator 650. The tuning prompts 704A, . . . , 704N may be determined based on model data from the target model and the tuples 702 included in the tuning dataset 648. The tuning prompts 704A, . . . , 704N may include a context portion 706, a feature portion 708, and an action portion 710. The context portion 706 may include a number of words or sentences that introduce an action for the LM perform. The context portion 706 may also explain the tuning dataset and the training process for the Target model. The tuning prompts 704A, . . . , 704N may include one or more tags 714 (e.g., shown in FIG. 7 as having the format <tag>) that serve as placeholders for pieces of the model data and the tuples 702 that may be embedded in the tuning prompts 704A, . . . , 704N. The feature portion 708 may include interpretability metrics for one or more features of the target model. The action portion 710 may include an action that will be performed by the LM.

The tuning prompts 704A, . . . , 704N may be provided to the tuning service. The tuning service may train a pre-trained LM using a training data 712 that includes a tuning prompt 704A and explanation 664 for each of the remaining feature vectors included in the tuning dataset. The tuning dataset service may prepare the training data 712 by aggregating tuning prompts 704A, . . . , 704N and explanations 664 for each of the remaining feature vectors in a standard format file (e.g., a JSON file, a JSONL file, an XML file, a YML file, and the like). The training data 712 may be organized as a series of training prompts with each training prompt including a tuning prompt and its corresponding explanation. The tuning service may train a tuned LM by providing the training prompts in the training data 712 to the pre-trained LM.

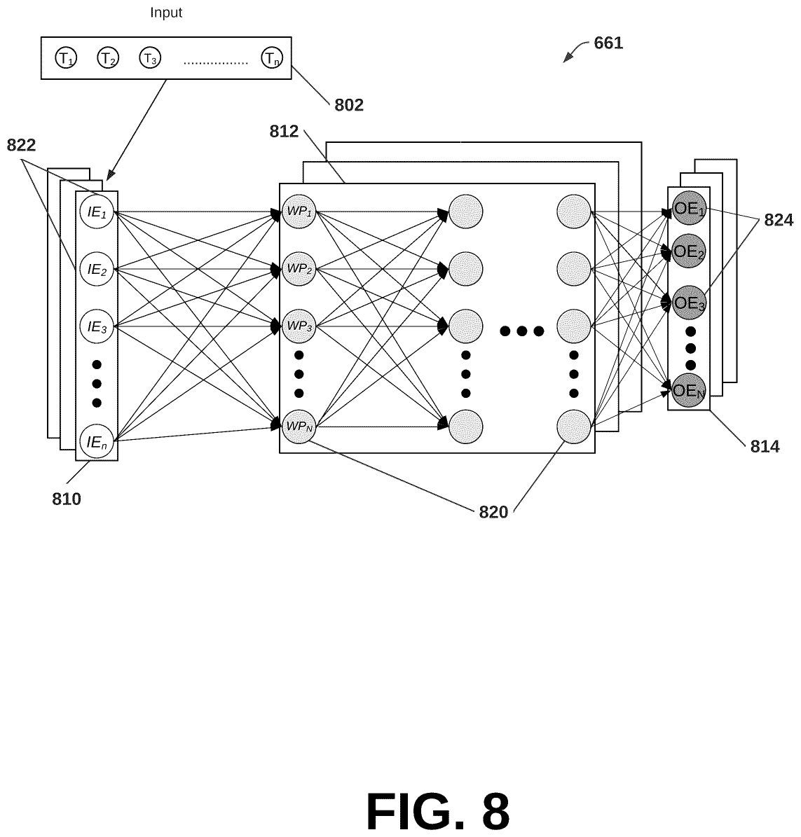

FIG. 8 illustrates an example of a model architecture for a pre-trained LM 661. In various embodiments, a deep neural network may be used to implement the pre-trained LM 661. The deep neural network may include one or more encoder layers 810, multiple hidden layers 812, and one or more decoder layers 814. Each layer may include one or more nodes. In various embodiments the encoder nodes 822 may tokenize the input text 802 into a sequence of tokens (e.g., individual words of sub-words) TI, . . . , TN and calculate input embeddings IE₁, . . . , IE_{N} for each token. The input embeddings transform the tokens into numerical representations that may be understood by the pre-trained LMs 661. The input embeddings may map each word in the input text 802 to a mathematical space that places similar words near each other to help the LMs understand the meaning of the words in the input text 802. The input embeddings may also include a positional encoding that represents the order of the words in the input text 802 in a numerical representation that may be understood by the pre-trained LMs 661.

The encoder layers 810 may also generate multiple hidden layers 812 that capture the meaning and the context of each token in the input text 802. Each of the hidden layers 812 may implement a self-attention mechanism that applies self-attention operations to the input embeddings. The self-attention operations may determine output embeddings for each token based on trained parameters WP₁, . . . , WP_{N} included in the hidden layer nodes 820 that store representations of the tokens in the training corpus at different levels of abstraction. One or more decoder layers 814 may determine output text by predicting a sequence of tokens based on the meaning and context stored in the input embeddings and the output embeddings for each token in the input sequence. To increase the accuracy of the predicted sequence of tokens the pre-trained LMs 661 may include millions or billions of trained parameters. The training process of the pre-trained LMs 661 may calculate values for the trained parameters that capture the meaning and context from huge corpuses of text data that include billions of words and sentences.

The trained parameters of the self-attention hidden layers 812 enables the LM to weight the importance of each token in input text 802 sequence while taking into account the relationships between all tokens and token dependencies. In various embodiments, the self-attention mechanism may include multiple attention heads with each head having its own set of trained parameters. The multiple attention heads enable the LM to focus on different aspects or patterns within the input text 802 simultaneously. Including multiple attention heads in each of the self-attention hidden layers 812 enables the LM to attend to different parts of the input sequence in parallel. The output embeddings output by the hidden layers 812 may be added element-wise to the input embeddings (e.g., the output embedding for each token is added to the input embedding for the corresponding token) to determine an aggregate output embedding. The aggregate output embedding from each of the hidden layers may be normalized to ensure the aggregate output embeddings from each of the hidden layers are on the same numerical scale. A feed forward neural network (e.g., a neural network including a few fully connected layers with rectified linear unit (ReLU) or other activation functions) may combine the normalized output embeddings from each of the hidden layers to determine a final output embeddings for each token. Combining the output embeddings from each of the hidden layers using a feed forward neural network enables the aggregate output embeddings to capture complex patterns and non-linear relationships among the input embeddings, trained parameters, and output embeddings.

For each piece of input text 802, the decoder layers 814 may generate a completion including one or more lines of natural language text. The decoder layers 814 may include multiple decoder nodes 824 that store one or more of the final output embeddings OE₁, . . . , OE_{N} that encode the learned information and contextual representation of the tokens based on the self-attention and feed forward operations performed by each of the hidden layers 812. The decoder layers 814 may decode the final output embeddings to generate a context-aware representation of the next token in a sequence. The context aware representations are then passed through a linear layer with a softmax activation function to convert the representations into probabilities. The linear layer may map the output embeddings to a higher-dimensional space to transform the output embeddings into the original input space (e.g., the vocabular of the input text). The decoder layers 814 may stochastically sample the next token based on the probability distribution determined by the linear layer. For example, the predicted probabilities determined by the linear layer may be mapped to a corresponding token in the pre-trained LM's vocabulary (e.g., English, French, Spanish, or other language the LM was trained to understand) and the token with the largest probability may be selected as the first output token.

To determine the next token in the sequence, output embeddings for the first token may be determined by the hidden layers and added to the set of final output embeddings. The decoder layer may repeat the decoding steps using the updated final output embeddings and the linear layer may determine the next token in the sequence based on the new probability distribution. The process of determining output embeddings for the most recently generated token, decoding the updated set of output embeddings, and predicting the next token based on updated probabilities may be repeated until a completion of a predetermined length is reached or an end-of-sequence token is determined.

Referring back to FIG. 6, during training, pre-trained LM 661 may learn the context and meaning of words included in the training prompts. The explanations included in the training data may be the example explanations used to measure the accuracy of the generated explanations determined by the tuned LM. To train the pre-trained LM 661, each training prompt included in the training data may be tokenized and the sequence of tokens determined for each prompt may be fed into the pre-trained LM. The encoder layers of the pre-trained LM may determine input embeddings and positional encodings for each token in a sequence. The hidden layers may determine output embeddings for each token based on the trainable parameters of the self-attention heads. The decoder layers may then predict a sequence of tokens including a generated explanation for the sample outcome based on probability distributions determined for the output embeddings. Each token in the generated explanation may be compared to the tokens of the example explanation in the training prompt.

In various embodiments, for each sample in the training dataset, the pre-trained LM 661 may be trained over multiple iterations. The number of iterations in the training process may match the number of tokens in the example explanation for each training prompt. During the first iteration, the pre-trained LM 661 may receive the training prompt as input and may generate the first token in the generated explanation as output. During the second iteration, the pre-trained LM 661 may receive the training prompt and the first token in the generated explanation as input and may generate the second token in the generated explanation as output. For each subsequent iteration, the pre-trained LM 661 may receive the training prompt and each previously predicted token in the generated explanation as input and may generate the next token in the generated explanation as output. Each token in the generated explanation may be compared to its corresponding token in the example explanation to determine an error value for the sample training prompt. For example, the first token in the generated explanation may be compared to the first token in the example explanation, the second token in the generated explanation may be compared to the second token in the example explanation and so one until the final token in the generated explanation is compared to the final token in the example explanation.

The tuning service 652 may calculate the error value using a loss function that measures the difference between the generated token and example token at each position in the generated explanation and example explanation respectively. For example, the loss function may determine a difference between the value of the output embeddings for each generated token and the value of an output embedding for the corresponding token in the example explanation. The loss function may determine an error value based on the differences between the output embedding values. The error values determined for each training prompt may be combined to determine an aggregated error value for the training dataset. A gradient function (e.g., gradient descent, stochastic gradient descent, and the like) or other optimization algorithm may be used to modify one or more trainable parameters (e.g., input embeddings, self-attention parameters, and the like) of the pre-trained LM based on the measured error.

For example, the gradient function may backpropagate the error measured by the loss function back through the hidden layers and/or decoder layers of the pre-trained LM by calculating a loss gradient for each trainable parameter and/or input embedding. The loss gradients determined by the decoder nodes may be partial derivatives of the loss function with respect to each parameter to determine the portion of the error value attributed to each parameter in the self-attention hidden layers and/or input embedding in the encoder layers. The tuning service 652 may adjust the trainable parameters and/or values for the input embeddings in the direction of the negative gradient by multiplying the current value of the weight and/or input embedding by a learning rate (e.g., 0.1 or any other predetermined step size) and subtracting the result from the gradient values to determine the updated parameter values and embedding values for each trainable parameter and input embedding respectively. In various embodiments, the learning rate used to train the tuned LMs may be larger than the learning rate used to train the pre-train LMs. The tuning service 652 may determine a tuned LM by setting the value for each trainable parameter to the updated parameter values and/or setting the value for each input embedding to the update embedding values.

During each training epoch, the trainable parameters and input embeddings of the pre-trained LMs 661 may be retrained based on the error value measured for each predicted token. An initial version of the pre-trained LM 661 may determine a generated explanation for each training prompt included in a training dataset. A loss function may determine an error value that measures the difference between each token in the generated explanations and the corresponding token in the example explanation. A gradient function may backpropagate the error back through the hidden layers by adjusting the trainable parameters based on the loss gradients for each parameter. The gradient function may also backpropagate the error back through the input embeddings in the encoder layers by adjusting each input embedding based on the loss gradient for each embedding. An initial tuned LM 662A may then be determined by adjusting the values of the trainable parameters and/or input embeddings in the pre-trained LM 661 to the adjusted parameter values and/or input embeddings. A next tuned LM 662N (e.g., a second tuned LM) may be determined by retraining the initial tuned LM 662A on a new training dataset determined from an updated tuning dataset 648 including one or more new and/or updated data samples. The initial tuned LM 662A may be retrained using the training process described above so that new iterations of the tuned LMs 662N may be determined over multiple training epochs to improve the performance of the tuned LMs 662A, . . . , 662N. After training, the tuned LMs 662A, . . . , 662N may be stored in the learning module 106 and may be published so that the model insights generator 608 may inference the published tuned LMs 662A, . . . 662N to generate explanations for outcomes determined by the target models.

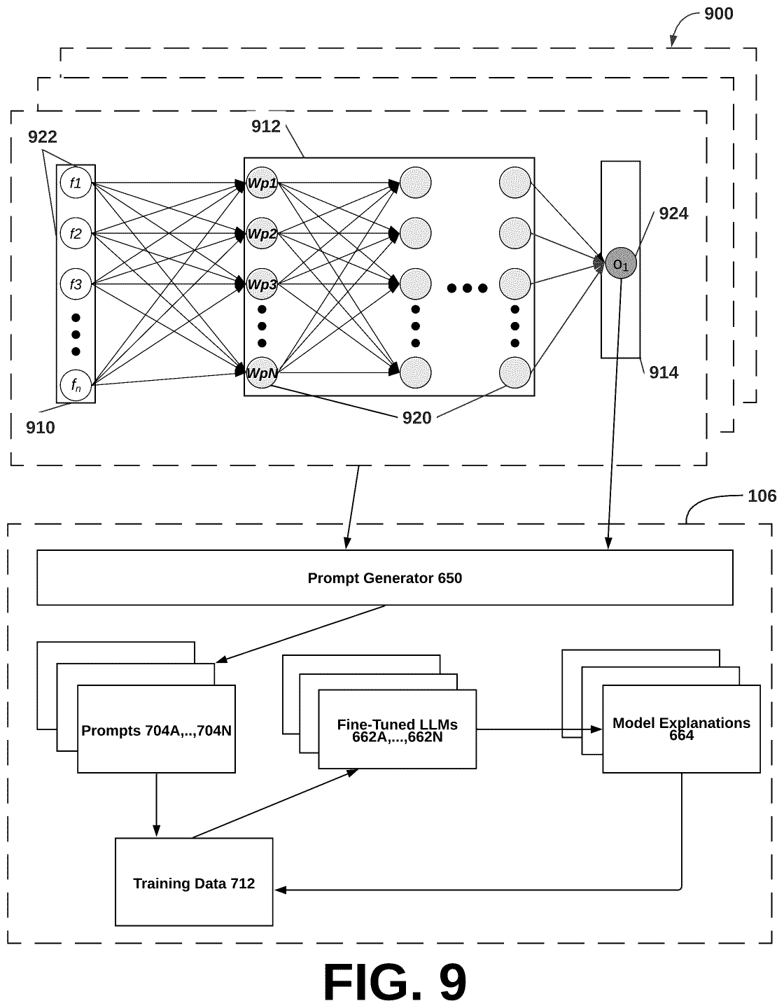

In various embodiments, the explanations generated by the tuned LMs 662A, . . . , 662N may be used to train an updated version of the tuned LMs to determine explanations for more complex target models. FIG. 9 illustrates an example training process for tuning an LM based on model explanations 664 (e.g., completions) generated by a previously published version of the tuned LM. The target models may include multiple versions of a neural network 900 trained to determine a particular type of outcome. Each version of the neural network 900 may include more features and/or more hidden layers 912 so that the complexity of each version of the neural network incrementally increases. The neural network 900 may include an input layer 910, multiple hidden layers 912, and an output layer 914. Each layer may include one or more nodes. In various embodiments the input layer nodes 922 may correspond to the features of a data sample (e.g., a n-dimension representation of a data sample (customer attributes, customer profile, campaign performance data, or other data record) to be analyzed by the neural network 900) and the output layer 914 may contain a single output layer node 924 that provides a numerical outcome for the data sample. For example, the output layer node 924 may provide a numerical score on a normalized (e.g., between 0 to 1) or continuous scale or other prediction, insight, or outcome.

During training, the weights for each of the parameters (Wp1, . . . , WpN) in each of nodes 920 included in the hidden layers 912 may be initialized using an initializer (e.g., a normal initializer that assigns random values for weights in a normal distribution). In various embodiments, initializing the nodes of the hidden layers may involve determining at least one initial value of one or more weights for hundreds of thousands of trainable parameters. An activation function (e.g., a rectified linear unit (ReLU) activation function) is then applied to the weighted sum output from each hidden layer node 920 to generate the output for the node. A second activation function (e.g., a sigmoid activation function, linear activation function, and the like) may be selected for the output layer 914 and used to determine a score from the weighted sums output by each of the hidden layers 912.

The learning module may train a pre-trained LM to explain how the neural network 900 generated a particular outcome using a seed model and an initial version of the neural network 900 (e.g., the least complex version of the neural network 900 generated by the explainability engine). To train the initial tuned LM to generate explanations 664 for outcomes determined by the more complex versions of the neural network 900, the prompt generator 650 may generate tuning prompts 704A, . . . , 704N using model data, determined outcomes, and interpretability metrics for one or more next versions of the neural network 900 (e.g., larger and more complex versions of neural network 900). For example, a tuning prompt 704A including the outcomes and SHAP values for the model features may be determined for each data sample included in a tuning dataset. The model explanations 664 for the data samples determined by the initial tuned LM (e.g., the tuned LM trained on the explanations from the seed and the initial version target model) and the tuning prompts 704A, . . . , 704N may be combined into training prompts that are aggregated as training data. The tuning service may then train a next tuned LM (e.g., a version of the initial tuned LM tuned for more complex target models) using the prompts generated from the model data, outcomes, and interpretability metrics from the next target model (a second version target model that is larger and more complex than the initial version of the target model) and model explanations from the initial tuned LM. Multiple next versions of the tuned LM may be trained in this manner until the tuning prompts 704A, . . . , 704N are generated using outcomes, model data, and interpretability metrics from the largest and most complex version of the neural network 900 and the training prompts are generated using the model explanations generated by the second largest and most complex version of the neural network 900.

Model explanations generated by the tunes LMs may be natural language expressions that identity the most important features in the target model's decision making process. The natural language expressions may also include an explanation for each of the features that indicates why the target model considered that feature important. For example, the model explanations may include one or more features of the model and the natural language explanation for each feature may include a description of how the value of the feature in particular data sample relates to the values of the feature across the entire training dataset of the model. The description may indicate how the value of the feature for the sample is distinguished from the values of the feature for other samples in the dataset. The description may also indicate how the feature value for the sample is similar to the feature values for other samples in the training dataset that received similar outcomes (e.g., were classified in the same class, have similar predicted values (e.g., a brand affinity within 0.1 or another predetermined threshold), and the like. The description may include a statistical relationship, threshold comparison, mathematical relationship, or other quantitative expression that relates the feature value to other feature values in the tuning dataset. The model explanations for the important features may be combined in a natural language response generated by the tuned LM. An example generated response including five model explanations is provided below.

This sample was classified as unlikely to convert because
Feature print_position was 3.5832 standard deviations greater than the mean
Feature category_id had weight of evidence greater than threshold −0.1952
Feature total_orders_item_30 days was 0.4136 standard deviations greater than the mean
Feature offset was 0.4174 standard deviations greater than the mean
Feature total_orders_item_30 days was 0.4136 standard deviations less than the mean

In various embodiments, generated responses for more complex target models with more model features may include more model explanations than generated responses for target models with a lower number of model features. The number of tokens included in each model explanation may also be greater for complex target models with more model features relative to target models with a lower number of model features. The increase in the number of model explanations and number of tokens in each explanation is provided by the bootstrapping approach described herein. For example, the progressive model tuning of the bootstrapping approach trains LMs on a set of model explanations and interpretability metrics (e.g., SHAP values) determined by and for increasingly complex models. The bootstrapping approach implemented in the model explainability engine uses training datasets incorporating inputs (e.g., explanations, interpretability metrics, and the like) from increasingly complex versions of the target model to tune LMs to the level of complexity of the target models that are evaluating and explaining. The bootstrapping approach builds the tuned LM's understanding of the outcome context and the relationships between the model features gradually over multiple training iterations with the understanding learned from the outcomes, model features, and explanations for each smaller and less complex version of the target model saved in the trainable parameters of the tuned LM and used to interpret the relationships between an expanded set of features included in the next version of the target model. Each iteration of the tuned LMs for a target model trained using the bootstrapping approach learns to generate model explanations based on a progressively detailed and nuanced set of training explanations and a larger and more diverse set of model features. Accordingly, each new tuned LM iteration is trained to identify and explain more complex relationships between individual features in a larger feature library. The more nuanced understanding of the decision making process of the target models may be conveyed in responses that include greater numbers of model explanations and more tokens for each explanation.

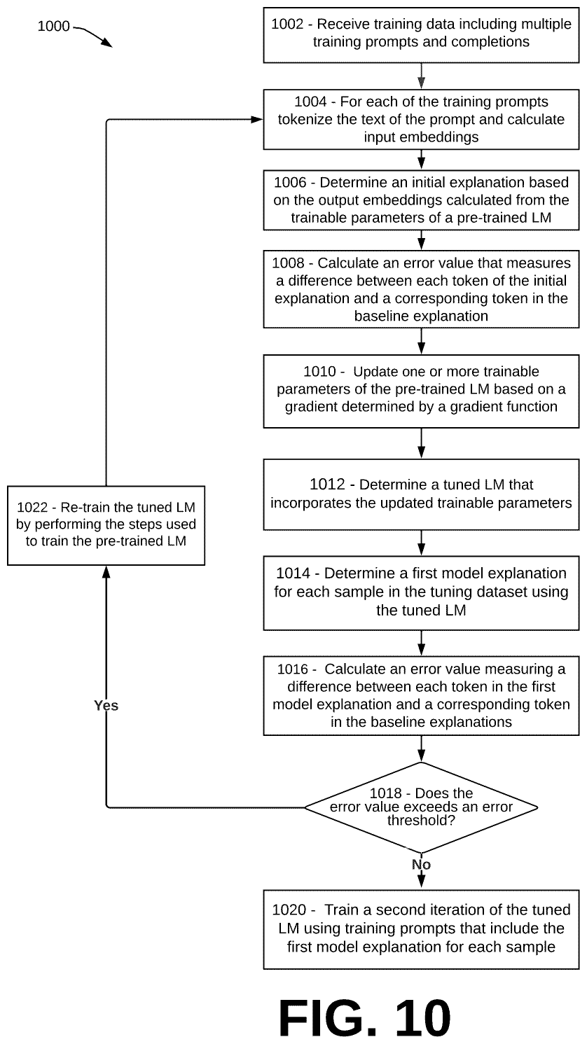

Some present examples also include methods. FIG. 10 is a block diagram of a process 1000 of training a tuned LM. At step 1002, a tuning service receives training data including prompts and response for a sample of feature vectors. Each of the training prompts may include an outcome determined by a target model and one or more interpretability metrics determined for one or more features of a target model. The responses may each include an example explanation for an outcome determined by a seed model. At step 1004, each of the training prompts are tokenized by one or more encoder layers of a pre-trained LM to generate a sequence of tokens. The encoder layers may also calculate input embeddings for each of the tokens. At step 1006, one or more decoder layers of the pre-trained LM may determine an initial explanation for each of the training prompts. The initial explanation may include a sequence of tokens predicted by the pre-trained LM that forms a natural language expression. The sequence of tokens may be predicted based on output embeddings calculated by the encoder layers based on trainable parameters included in the hidden layers of the pre-trained LM.

At step 1008, the initial generated explanation determined for each prompt is compared to the example explanation in the training dataset. An error function that measures the difference between each token in the initial generated explanation and the corresponding token in the example explanation may be used for the comparison. The error function may calculate an error value token by token and aggregate error value for the example feature vector. After each token is generated by the pre-trained LM, the token may be appended to a response token sequence that is included in the training prompt. The updated training prompt with the previously generated tokens may be tokenized and used to determine the next token in the initial explanation. The error value for the next token is then calculated. The process of predicting a token, calculating an error value for the token, appending the token to the training prompt, and predicting the next token using the updated training prompt may be repeated until an end of sequence token is generated. This process enables the model to determine the next token in the initial explanation based on the outcome and the interpretability metrics in the initial training prompt and all of the previously predicted tokens in the explanation. The aggregate error values for each example feature vector may be combined by the error function to determine a final error value for the sample of feature vectors.

At step 1010, the trainable parameters of the pre-trained LM may be updated based on the error value. A gradient function or other optimization function may be used to determine how to modify the trainable parameters. For example, a gradient function may be used to calculate a gradient based on the error value. The gradient may be multiplied by a learning rate and applied to each of the trainable parameters in the direction of the loss (e.g., the production of the gradient and the learning rate may be added to each of the trainable parameters) to backpropagate the loss through the model. The values for the trainable parameters in the pre-trained LM may be modified based on the determined gradient and a learning rate to determine updated trainable parameters. At step 1012, a tuned LM may be determined by incorporating the updated trainable parameters into the LM.

At step 1014, the tuned LM may determine a first generated explanation for each sample in the training dataset by repeating steps 1004 and 1006 using the tuned LM. At step 1016, a final error value for each data sample in the training dataset may be determined by comparing the first generated explanation to the example explanation as described above in step 1008. At step 1018, the final error value for the tuned LM may be compared to a pre-determined error threshold (e.g., 0.2, 0.1, and the like). If at step 1018, the aggregate error value of the first generated explanations for the training sample exceeds the error threshold (yes at 1018), the tuned LM may be retrained at step 1022 by performing steps 1004-1012. To facilitate re-training the tuned LM, one or more aspects of the training data (e.g., more training data samples, an entirely new set of prompts and response, and the like), model (more trainable parameters, more input embeddings, different output embeddings, and the like), and/or hyperparameters (e.g., learning rate) may be modified during the re-training process.

If at step 1018, the error value for the first generated explanations does not exceeds the error threshold (no at step 1018) a second iteration of the tuned LM may be trained at step 1020. The training prompts of the training dataset for the second iteration of the tuned LM may be updated to include outcomes determined by a more larger and more complex target model (e.g., a next version of the target model including more parameters than the version target model used to determined the initial training dataset). The training prompts for the second iteration of the tuned LM may also include one or more interpretability metrics calculated for the features of the more complex target model. The responses included in the training dataset may also be updated to include the first generated explanations determined by the initial tuned LM. Steps 1004-1012 may be repeated to train the second iteration of the tuned LM using the updated training dataset. Additional iterations of the tuned LM may be determined using this training process until the training dataset is generated using the outcomes and interpretability metrics for the most complex version of the target model and example explanations determined by the second most complex version of the target model.

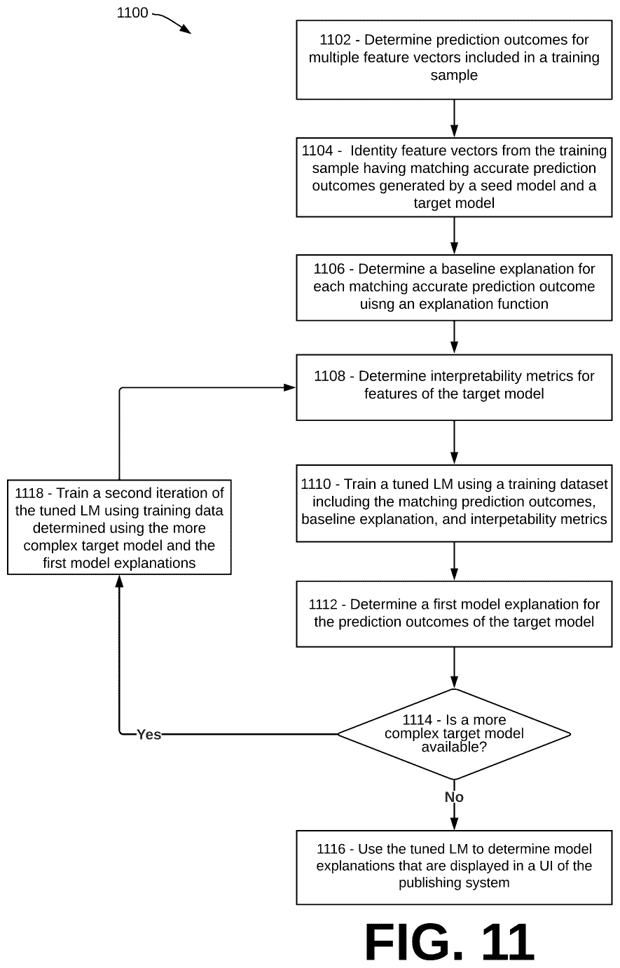

FIG. 11 is a block diagram illustrating a example process 1100 for determining an explanation for an outcome determined by a target model. At step 1102, a seed model and a target model may determine outcomes for multiple data samples included in a training sample. The seed and target models may be one of many different versions of a machine learning model trained to predict one or more outcomes (e.g., a classification, a continuous value, and/or other type of prediction and/or insight). The training sample may include feature vector representations for multiple data samples (e.g., an identity record, transaction history, customer profile, campaign performance data, or other record). The training sample may also include a known outcome (e.g., continuous value prediction, classification, insight, and the like) for each of the data samples.

At step 1104, the outcomes determined by the seed and target models may be evaluated to determine the accuracy of each of the outcomes predicted and isolate the data samples where the seed and class models agree. Model accuracy may be determined by comparing the outcomes determined by the seed and target models respectively to the known outcomes in the training sample. The data samples in the training sample that have accurate, matching outcomes determined by both the seed and target models (i.e., samples where the models determined the same accurate outcome) may be identified. At step 1106, an explanation function may iterate through the seed model to determine a baseline explanation for each matching, accurate outcome. The baseline explanation may identify the important features considered by the seed model during the outcome determination process and give insight about how the values of the important features caused the seed to determine its outcome. At step 1108, one or more interpretability metrics (e.g., SHAP values) may be determined for the features of the target model that were used to generate each of the matching, accurate outcomes. The identified data samples and the baseline explanation and interpretability metrics for each matching, accurate outcome may be combined to generate a training dataset.

At step 1110 a tuned LM may be trained using the training dataset as described above in FIG. 10. At step 1112, the tuned LM may determine a first model explanation for each of the matching, accurate outcomes of the target model. The first model explanation may be a sequence of tokens predicted by the tuned LM that form a natural language expression describing the important features considered by the target model during its decision making process and how the feature values determined by the model during its evaluation of the feature vector impacted the determined outcome.

At step 1114, the version of the target model used to train the tuned LM may be evaluated to determine if the most complex target model was used to determine the training data for the tuned LM. The complexity of the target models may be determined based on the size (e.g., the amount of memory or storage occupied by the model file, the number of features included in each model, and the like). If a more complex version of the target model (e.g., a larger target model and/or a target model having more features than the target model used to determine the training data) is available (Yes at step 1114), a second iteration of the tuned LM may be trained at step 1118. The second iteration of the tuned LM may be trained using training data determined using the more complex target models (e.g., outcomes determined by the larger and more complex version of target model and interpretability metrics determined for the features of the larger and more complex target model) and the first generated explanations determined by the initial tuned LM. This process of training a new iteration of the tuned LM using training data form a larger and more complex target model and the model explanations from the previous iteration of the tuned LM may be repeated until the tuned LM is trained to determine model explanations for the largest and most complex target model available for an outcome. If a larger and more complex target model for the outcome is not available (no at step 1114), the tuned LM may be stored and published (e.g., deployed to a production environment) and used to determine model explanations that are displayed in a UI of the publishing system at step 1116.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors; and
a memory storing instructions that, when executed by at least one processor in the one or more processors, cause the at least one processor to perform at least the following operations:
determine, by a seed model, outcomes for multiple data samples included in a training sample;
determine, by an initial target model, outcomes for the multiple data samples;
identify one or more of the multiple data samples having the outcome determined by the initial target model matching the outcome from the seed model;
for each of the identified one or more data samples, determine an example explanation for the outcomes determined by the seed model by iterating though the seed model to determine one or more model features of the seed model that user used to determine the outcome;
determine multiple interpretability metrics for the outcome determined by the initial target model based on model data and outcome data of the initial target model;
determine training data for training a language model (LM), the training data including multiple training prompts and an example response for each prompt, the multiple training prompts each including the outcome from the seed model and multiple interpretability metrics for the features of the initial target model, each example response including the example explanation for the outcome included in each prompt; and
train an initial tuned LM to determine natural language explanations for outcomes generated by the initial target model by updating one or more trainable parameters of a pre-trained LM based an error value that measures a difference between initial generated explanations determined by the pre-trained LM and the example explanation for each of the identified data samples.

2. The system of claim 1, wherein the processor is further configured to train the initial tuned LM by:
calculating the error value using an error function that compares each token of each initial generated explanation to a token in the example explanation having a corresponding position;
determining a gradient for each of the trainable parameters of the pre-trained LM using a gradient descent function;
adjusting each of the trainable parameters based on the determined gradient and a learning rate; and
determining the initial tuned LM using the adjusted trainable parameters.

3. The system of claim 1, wherein the processor is further configured to determine a natural language explanation for a new outcome from the initial target model using the initial tuned LM; and
display the natural language explanation and the new outcome in a user interface (UI) for configuring a content campaign.

4. The system of claim 3, wherein the natural language explanation is displayed in a popup menu or hover UI in response to a user interaction with an object in the user interface that displays the new outcome.

5. The system of claim 1, wherein the processor is further configured to train a second tuned LM to determine natural language explanations for outcomes generated by a second target model,
the second tuned LM trained by updating the trainable parameters of the second tuned LM based an error value that measures a difference between an updated generated explanation determined by the second tuned LM and the initial generated explanation for each of the identified data samples determined by the initial tuned LM.

6. The system of claim 5, wherein the second target model includes a larger number of trainable parameters relative to the initial target model.

7. The system of claim 5, wherein a training dataset used to train the second tuned LM includes an outcome for each of the identified data samples determined by the second target model and interpretability metrics for a set of features used by the second target model to determine each outcome.

8. The system of claim 1, wherein the multiple interpretability metrics include a SHAP value calculated using a SHAP function.

9. The system of claim 1, wherein the multiple interpretability metrics include at least one interpretability metric for each feature included in the initial target model.

10. A method comprising:
determining, by a seed model, outcomes for multiple data samples included in a training sample;
determining, by an initial target model, outcomes for the multiple data samples;
identifying one or more of the multiple data samples having the outcome determined by the initial target model matching the outcome from the seed model;
for each of the identified one or more data samples, determining an example explanation for the outcomes determined by the seed model by iterating though the seed model to determine one or more model features of the seed model that user used to determine the outcome;
determining multiple interpretability metrics for the outcome determined by the initial target model based on model data and outcome data of the initial target model;
determining training data for training a language model (LM), the training data including multiple training prompts and an example response for each prompt, the multiple training prompts each including the outcome from the seed model and multiple interpretability metrics for the features of the initial target model, each example response including the example explanation for the outcome included in each prompt; and
training an initial tuned LM to determine natural language explanations for outcomes generated by the initial target model by updating one or more trainable parameters of a pre-trained LM based an error value that measures a difference between initial generated explanations determined by the pre-trained LM and the example explanation for each of the identified data samples.

11. The method of claim 10, wherein the initial tuned LM is trained by:
calculating the error value using an error function that compares each token of each initial generated explanation to a token in the example explanation having a corresponding position;
determining a gradient for each of the trainable parameters of the pre-trained LM using a gradient descent function;
adjusting each of the trainable parameters based on the determined gradient and a learning rate; and
determining the initial tuned LM using the adjusted trainable parameters.

12. The method of claim 10 further comprising determining a natural language explanation for a new outcome from the initial target model using the initial tuned LM; and
displaying the natural language explanation and the new outcome in a user interface (UI) for configuring a content campaign.

13. The method of claim 12, wherein the natural language explanation is displayed in a popup menu or hover UI in response to a user interaction with an object in the user interface that displays the new outcome.

14. The method of claim 10, further comprising training a second tuned LM to determine natural language explanations for outcomes generated by a second target model, the training by updating the trainable parameters of the second tuned LM based an error value that measures a difference between an updated generated explanation determined by the second tuned LM and the initial generated explanation for each of the identified data samples determined by the initial tuned LM.

15. The method of claim 14, wherein the second target model includes a larger number of trainable parameters relative to the initial target model.

16. The method of claim 14, wherein a training dataset used to train the second tuned LM includes an outcome for each of the identified data samples determined by the second target model and interpretability metrics for a set of features used by the second target model to determine each outcome.

17. The method of claim 14, wherein the multiple interpretability metrics include a SHAP value calculated using a SHAP function.

18. The method of claim 10, wherein the multiple interpretability metrics include at least one interpretability metric for each feature included in the initial target model.

19. A non-transitory computer-readable medium comprising instructions which, when executed by at least one processor, cause the machine to perform operations comprising:
determining, by a seed model, outcomes for multiple data samples included in a training sample;
determining, by an initial target model, outcomes for the multiple data samples;
identifying one or more of the multiple data samples having the outcome determined by the initial target model matching the outcome from the seed model;
for each of the identified one or more data samples, determining an example explanation for the outcomes determined by the seed model by iterating though the seed model to determine one or more model features of the seed model that user used to determine the outcome;
determining multiple interpretability metrics for the outcome determined by the initial target model based on model data and outcome data of the initial target model;
determining training data for training a language model (LM), the training data including multiple training prompts and an example response for each prompt, the multiple training prompts each including the outcome from the seed model and multiple interpretability metrics for the features of the initial target model, each example response including the example explanation for the outcome included in each prompt; and
training an initial tuned LM to determine natural language explanations for outcomes generated by the initial target model by updating one or more trainable parameters of a pre-trained LM based an error value that measures a difference between initial generated explanations determined by the pre-trained LM and the example explanation for each of the identified data samples.

20. The non-transitory computer-readable medium of claim 19, wherein the multiple interpretability metrics include at least one interpretability metric for each feature included in the initial target model.
